(19) United States
(12) Patent Application Publication
(10) Pub. No.: US 2022/0227916 A1
(43) Pub. Date: Jul. 21, 2022

(54) COMPATIBILIZED BLENDS OF TEREPHALATE ESTER POLYOLS AND HYDROCARBON BLOWING AGENTS

(71) Applicant: Dow Global Technologies LLC, Midland, MI (US)

(72) Inventors: Federico La Terra, Correggio (IT); Giuseppe Vairo, Correggio (IT); Luigi Bertucelli, Correggio (IT)

(21) Appl. No.: 17/608,530

(22) PCT Filed: Apr. 20, 2020
(86) PCT No.: PCT/US2020/028917

§ 371 Date: Nov. 3, 2021

(30) Foreign Application Priority Data
May 16, 2019 (IT) 102019000006906

(51) Int. Cl. C08G 18/42; C08J 9/14; C08J 9/00; C08G 18/09; C08G 18/76

(52) U.S. Cl. CPC C08G 18/4213; C08J 9/141; C08J 9/0061; C08G 2101/00; C08G 18/7664; C08G 2110/0025; C08G 18/092

(57) ABSTRACT

Formulated polyol compositions contain a terephthalic acid-based polyester polyol, a C4-7 hydrocarbon blowing agent, and a nonionic surfactant that has a hydrophilic-lipophilic balance of greater than 13 to 18.5. The formulated polyol compositions exhibit surprisingly good storage stability and resist stratifying into layers. The compositions are useful to make rigid polyurethane and/or polyisocyanurate foams. The good compatibility of the blowing agent leads to improved cell structure in the foams.

This invention relates to blends of terephthalate ester polyols and hydrocarbon blowing agents, and to rigid foams made from such blends.

Rigid polyurethane/polyisocyanurate foams are commonly used as thermal insulation in appliances in buildings and for other uses. The foams are made industrially by reacting one or more polyols with one or more isocyanates in the presence of a blowing agent. Polyester polyols are favored in these applications because they provide better foam properties. Commonly available polyester polyols used in these applications include those based on orthophthalic or terephthalic acid (or their respective anhydrides).

Hydrocarbons are commonly used as the blowing agent, by themselves or in conjunction with water, which reacts with isocyanate groups to produce carbon dioxide.

It is usually preferred to produce the foam by making a formulated polyol component that is then reacted with the polyisocyanate(s). The formulated polyol component contains the polyester polyol and the hydrocarbon blowing agent, and usually contains water (when used), a foam-stabilizing surfactant and catalysts.

The formulated polyol component may be stored for significant amounts of time before it is processed into foam. Accordingly, the mixture of polyol and blowing agent needs to be storage-stable in such a case. In particular, the components of the formulated polyol component need to form a composition that remains homogeneous over a period of hours to days or longer.

Compatibility is important even in cases in which the blowing agent is not combined with the polyol until the time the foam is prepared. If the blowing agent is inadequately compatible with the polyol, a homogeneous reaction mixture will not be produced. A homogeneous mixture is needed to ensure homogeneous foam and good processing.

Unfortunately, hydrocarbon blowing agents have limited solubility in the polyester polyols. These blowing agents do not dissolve into the polyester polyol easily and even when dissolved, the polyol/hydrocarbon mixture tends to stratify and separate.

Poor compatibility of the blowing agent with the polyol can cause defects in the foam. Large pores can form because the blowing agent tends to phase separate as the form-forming reaction takes place. This leads to high localized concentrations of blowing agent that produce large pores. The large pores are unacceptable from both performance and cosmetic standpoints.

To combat these issues, it has been proposed to include various additives in the formulated polyol component to help compatibilize various types of polyols with a hydrocarbon blowing agent, and/or to modify the polyester polyol.

U.S. Pat. No. 5,922,779 illustrates the problem. As described in this document, blends of a phthalic anhydride/diethylene glycol polyester polyol and a mixture of pentanes phase separate over a short period of time. Adding nonionic surfactants does not resolve the problem. The solution proposed in U.S. Pat. No. 5,922,799 is to modify the polyester with hydrophobic groups in addition to incorporating certain nonionic surfactants into the polyol formulation.

WO 2007/094780 describes blends of a polyol, a hydrocarbon blowing agent and certain nonionic surfactants. As shown in the examples of this reference, large amounts of surfactants are needed to compatibilize n-pentane with even a hydrophobically modified phthalic acid-based polyol.

U.S. Pat. No. 6,245,826 describes compatibilizing a phthalic anhydride-initiated polyester polyol with a hydrocarbon blowing agent using a fatty alcohol ethoxylate having an HLB of 7 to 12. U.S. Pat. No. 5,464,562 describes a similar approach.

For certain applications, polyols based on terephthalic acid are preferable to those based on orthophthalic acid. The terephthalic acid-based polyols have different solubility characteristics than the orthophthalic acid-based ones. Strategies for compatibilizing orthophthalic acid-based polyols with hydrocarbon blowing agents have not been successful when the polyol is replaced with a terephthalic acid based polyol.

A polyol composition containing a terephthalic acid-based polyol and a hydrocarbon blowing agent, in which the hydrocarbon blowing agent exhibits good compatibility with the polyol, is desired.

This invention is in one aspect a formulated polyol composition comprising the following components:
a) at least one polyester polyol containing one or more terephthalic acid ester groups, the polyester polyol having a number average of at least 1.5 hydroxyl groups per molecule and a hydroxyl number of 150 to 350, or a mixture of at least 50 weight-% based on the weight of the mixture of the polyester polyol with up to 50 weight-% of one or more other polyols having a number average of at least 1.5 hydroxyl groups per molecule and a hydroxyl number of 150 to 350;
b) 5 to 30 parts by weight, per 100 parts by weight of component a), of one or more aliphatic hydrocarbons having 4 to 7 carbon atoms;
c) 0.25 to 20 parts by weight, per 100 parts by weight of component a), of one or more nonionic surfactants having a hydrophilic-lipophilic balance (HLB) of greater than 13 and up to 18.5.

The invention is also a method of making a polymeric foam, comprising
A) forming a reaction mixture containing
a) at least one polyester polyol containing one or more terephthalic acid ester groups, the polyester polyol having a number average of at least 1.5 hydroxyl groups per molecule and a hydroxyl number of 150 to 350, or a mixture of at least 50 weight-% based on the weight of the mixture of the polyester polyol with one or more other polyols having a number average of at least 1.5 hydroxyl groups per molecule and a hydroxyl number of 150 to 350;
b) 5 to 30 parts by weight, per 100 parts by weight of component a), of one or more aliphatic hydrocarbons having 4 to 7 carbon atoms;
c) 0.25 to 20 parts by weight, per 100 parts by weight of component a), of one or more nonionic surfactants having a hydrophilic-lipophilic balance (HLB) of greater than 13 and up to 18.5;
d) one or more foam-stabilizing surfactants;
e) one or more urethane and/or isocyanate trimerization catalysts and
f) at least one organic polyisocyanate in an amount sufficient to provide an isocyanate index of at least 90 and
B) curing the reaction mixture under conditions such that component b) volatilizes and components a) and f) react to produce the polymeric foam.

The invention is also a polymeric foam made in the foregoing process.

Surfactants that are capable of compatibilizing orthophthalic-based polyester polyols with hydrocarbon blowing agents have been found to be ineffective when the orthophthalic-based polyester is replaced with a terephthalic acid-based one. Unexpectedly, the selection of a high HLB surfactant provides excellent compatibility between the terephthalate-based polyester polyol and the hydrocarbon blowing agent. These results are obtained even when the terephthalate-based polyester polyol does not contain hydrophobic chains. This permits simple and inexpensive terephthalic-based polyester polyols to be used. Formulated polyol compositions of the invention stratify into layers slowly if at all, and therefore produce a more consistent foam product when processed into foam.

Component a) of the formulated polyol composition is a polyester polyol containing one or more terephthalic acid ester groups, the polyester polyol having at least 2 hydroxyl groups per molecule and a hydroxyl number of 150 to 350. This polyester polyol is sometimes referred to herein as “terephthalate-based” for convenience.

Terephthalic ester groups are represented by the structure:

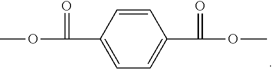

wherein the terminal oxygen atoms each are bonded to another carbon atom (not shown).

The terephthalate-based polyester polyol is in some embodiments a reaction product of reactants that include terephthalic acid and/or terephthalic anhydride with one or more aliphatic polyols that have a hydroxyl equivalent weight of up to 125, preferably up to 100, up to 75 or up to 60. This polyol may contain 2 to 8 hydroxyl groups, but it preferably contains no more than 3 hydroxyl groups. An especially preferred polyol is a diol or a mixture of a diol with a triol. Examples of such polyols include, for example, ethylene glycol, diethylene glycol, propylene glycol, dipropylene glycol, tripropylene glycol, 1,3-propanediol, 1,4-butanediol, 1,5-pentanediol, 1,6-hexanediol, 2-methyl-1,3-propanediol, glycerin, trimethylolpropane, trimethylolethane, pentaerythritol, erythritol, mannitol, sucrose, sorbitol and the like, as well as alkoxylates of any of the foregoing that have a hydroxyl equivalent weight of up to 125. The polyol is used in excess so as to produce a polyester having terminal hydroxyl groups and few if any residual carboxyl groups.

The terephthalate-based polyester polyol may be modified, such as in the manner described in U.S. Pat. No. 6,359,022, to introduce pendant aliphatic hydrocarbyl groups that contain 6 or more carbon atoms in a straight or branched chain. An advantage of this invention, however, is that such modifications are not needed to obtain adequate compatibilization of the terephthalate-based polyester polyol and the hydrocarbon. Thus, in preferred embodiments, the terephthalate-based polyester polyol does not contain such pendant aliphatic hydrocarbon groups of 6 or more carbon atoms.

The terephthalate-based polyester polyol in some embodiments has a hydroxyl functionality (number average of hydroxyl groups per molecule) of 1.5 to 2.5 and a hydroxyl number of 200 to 330, especially 200 to 275. In a particularly preferred embodiment, the terephthalate-based polyester polyol is a reaction product of terephthalic acid and/or terephthalic anhydride with ethylene glycol and/or diethylene glycol and/or a higher polyethylene glycol.

The terephthalate-based polyester polyol constitutes at least 50% by weight of all polyols having a functionality of at least 2 and a hydroxyl number of 150 to 350. It may constitute at least 60%, at least 75%, at least 85% or at least 90% thereof and may constitute up to 100% thereof or up to 95% thereof.

Other polyols having hydroxyl numbers of 150 to 350 may be present in component a). Examples of these include other polyester polyols, such as phthalate-based polyester polyols formed in a reaction of phthalic acid and/or phthalic anhydride, with a polyol that has a hydroxyl equivalent weight of up to 125, and optionally a fatty acid or plant oil. Other polyols that may be present include polyether polyols, polyether carbonates, other polyester polyols, and the like, in each case having a hydroxyl number of 150 to 350 and at least 2 hydroxyl groups per molecule.

Component b) is one or more hydrocarbons having 4 to 7 carbon atoms. The hydrocarbons are preferably aliphatic. They may be linear, branched and/or cyclic. Examples include n-butane, isobutane, n-pentane, isopentane, neopentane, cyclopentane, methyl cyclopentane, n-hexane, 2- and/or 3-methyl pentane, cyclohexane, n-heptane, 2-, 3- and/or 4-methyl hexane, methylcyclohexane, 1-butene, 2-butene, 1-pentene, 2-pentene, 1-hexene, 2-hexene, 1-heptene, 2-heptene, 3-heptene and the like, as well as mixtures of any two or more thereof. A preferred hydrocarbon includes at least 50 weight percent, preferably at least 80, at least 95% or at least 98% weight percent, of one or more pentane isomers.

The hydrocarbon is present in an amount of 5 to 30, especially 10 to 30 or 15 to 25 parts by weight, per 100 parts by weight of component a).

Component c) is a nonionic surfactant having an HLB of greater than 13 and up to 18.5. The HLB is preferably at least 13.5, at least 14, at least 14.5 or at least 15. The HLB in some embodiments is up to 18.3 or up to 18. HLB is calculated as 20×Mₕ/M, where Mₕ is the weight of the hydrophilic portion of the surfactant molecule and M is the total mass of the surfactant molecule.

The nonionic surfactant may be a room temperature (23° C.) liquid, solid or waxy material. It may have a molecular weight of, for example, at least 600 or at least 1000, and up to 20,000 or up to 10,000.

The nonionic surfactant may have one or more hydroxyl groups per molecule, but preferably not more than three or not more than two hydroxyl groups. Its hydroxyl equivalent weight in such a case is preferably at least 600.

The nonionic surfactant typically includes at least one poly(oxyethylene) block wherein the poly(oxyethylene) block or blocks constitute at least 65% of the total weight of the surfactant. The poly(oxyethylene) block or blocks in general constitute the hydrophilic portion of the surfactant molecule.

The nonionic surfactant further contains at least one hydrophobic block, which hydrophobic block or blocks constitute 7.5 to 35% of the total weight of the surfactant molecule. The hydrophobic block or blocks may be, for example, a hydrocarbon block containing at least 6, at least 8, at least 10 or at least 12 carbon atoms. Such a hydrocarbon block may be, for example, a straight- or branched chain aliphatic hydrocarbon block, an aromatic group, an aralkyl group, an alkaryl group and the like. The hydrophobic block may instead be, for example, a polyether block in which the repeating ether groups have 3 or more carbon atoms (such as a polypropylene oxide), poly(butylene oxide) and/or poly(tetramethylene glycol) block).

The nonionic surfactant is preferably devoid of terephthalate- or phthalate ester groups.

Examples of useful nonionic surfactants include ethoxylates of fatty alcohols and/or fatty acids; block copolymers of propylene oxide and/or butylene oxide and ethylene oxide, including diblock and triblock copolymers; ethoxylates of polyethylene oligomers; and the like.

Suitable surfactants that are commercially available include Pluronic™ PE10400 and Pluronic™ L-68LF, each available from BASF; Tergitol 15-5-15 and Tergitol 15-S-40, each available from The Dow Chemical Company; and PE-PEG MW 2250 from Merck.

The formulated polyol composition contains 0.25 to 20 parts by weight of the surfactant, per 100 parts by weight of component a). In some embodiments the formulated polyol composition may contain at least 0.5 part or at least 0.75 part by weight thereof and up to 15 parts, up to 12.5 parts, up to 10 parts, up to 7.5 parts, up to 6.5 parts, up to 6 parts or up to 5.5 parts by weight thereof, on the same basis.

The formulated polyol composition may contain other ingredients in addition to components a), b) and c).

Among the optional ingredients is a d) foam-stabilizing surfactant. The foam-stabilizing surfactant is a material that helps stabilize the gas bubbles formed by the blowing agent during the foaming process until the polymer has cured. A wide variety of silicone surfactants as are commonly used in making polyurethane foams can be used in this invention. The silicone surfactant may include polyether chains such as poly(ethylene oxide), poly(propylene oxide) or random or block chains of copolymerized ethylene oxide and propylene oxide. Examples of such silicone surfactants are commercially available under the trade names Tegostab™ (Evonik Industries AG), Niax™ (Momentive Performance Materials) and Dabco™ (Air Products and Chemicals).

The silicone foam-stabilizing surfactant may constitute, for example, 0.01 to 5 weight percent of the component a).

Another optional ingredient of the formulated polyol composition is e) a urethane and/or isocyanate trimerization catalyst. For purposes of this invention, a urethane catalyst is a catalyst for the reaction of an isocyanate group with an alcohol and/or water. Suitable catalysts include, for example, tertiary amines, cyclic amidines, tertiary phosphines, various metal chelates, acid metal salts, strong bases, various metal alcoholates and phenolates and metal salts of organic acids. Examples of metal-containing catalysts are tin, bismuth, cobalt and zinc salts. Examples of tertiary amine catalysts include trimethylamine, triethylamine, N-methylmorpholine, N-ethylmorpholine, N,N-dimethylbenzylamine, N,N-dimethylethanolamine, N,N,N′,N′-tetramethyl-1,4-butanediamine, pentamethyldiethylenetriamine, N,N-dimethylcyclohexylamine, N,N-dimethylpiperazine, 1,4-diazobicyclo-2,2,2-octane, bis(dimethylaminoethyl)ether, triethylenediamine and dimethylalkylamines where the alkyl group contains from 4 to 18 carbon atoms. Mixtures of these tertiary amine catalysts are often used.

A reactive amine catalyst, such as DMEA (dimethylethanolamine) or DMAPA (dimethylaminopropyl amine), or an amine-initiated polyol different from component a) may also be used.

Tin catalysts include stannic chloride, stannous chloride, stannous octoate, stannous oleate, dimethyltin dilaurate, dibutyltin dilaurate, tin ricinoleate, other tin compounds of the formula SnRₙ(OR)₄₋ₙ, wherein R is alkyl or aryl and n is 0 to 4, dialkyl tin mercaptides, dialkyl tin thioglycolates and the like. Zinc and tin catalysts are generally used in conjunction with one or more tertiary amine catalysts, if used at all.

Urethane catalysts are typically used in small amounts, the amount of all catalysts combined suitably constituting 0.0015 to 4.5 percent of the total weight of components b)-e). A preferred amount is up to 2 percent, up to 1.5 percent or up to 1.0 percent, on the same basis. Zinc and tin catalysts are generally used in very small amounts within this range, such as from 0.0015 to 0.25 weight percent on the same basis.

The isocyanate trimerization catalyst is a material that promotes the reaction of isocyanate groups with other isocyanate groups to form isocyanurate rings. Useful isocyanate trimerization catalysts include strong bases such as alkali metal phenolates, alkali metal alkoxides, alkali metal carboxylates, quaternary ammonium salts and the like. The alkali metal is preferably sodium or potassium. Specific examples of such trimerization catalysts include sodium p-nonylphenolate, sodium p-octyl phenolate, sodium p-tert-butyl phenolate, sodium acetate, sodium 2-ethylhexanoate, sodium propionate, sodium butyrate, the potassium analogs of any of the foregoing, trimethyl-2-hydroxypropylammonium carboxylate salts, and the like. The isocyanate trimerization catalyst may be present in a catalytic quantity, such as from 0.05 to 10 parts by weight per 100 parts by weight of component a). In specific embodiments, this catalyst may be present in an amount of at least 0.1, 0.25, 0.5 or 1 part by weight per 100 parts by weight of component a), and may be present in an amount up to 7.5, up to 5 or up to 2.5 parts by weight per 100 parts by weight of component a).

The formulated polyol formulation of the invention may contain g) one or more other polyols in addition to the component a). If present, these polyols may constitute, for example up to up to 25%, up to 10% or up to 5% of the combined weight of components a) and g). Examples of such other polyols include, for example, one or more polyols having a hydroxyl number of less than 150, such as from 20 to 150 or 30 to 150. Such a polyol may be, for example, a polyether polyol, a polyester polyol a natural oil polyol such as castor oil, “blown” soybean oil and the like. Component g) may include one or more polyols having a hydroxyl number of greater than 350, such as, for example, glycerin, trimethylolpropane, triethanolamine, ethylene glycol, diethylene glycol, triethylene glycol, propylene glycol, dipropylene glycol, tripropylene glycol, penterythritol, erythritol, sorbitol, sucrose or an alkoxylate of any one or more of the foregoing having a hydroxyl number of greater than 350.

In addition to the foregoing components, the reaction mixture may contain one or more fillers and/or reinforcing agents such as fiber glass, carbon fibers, flaked glass, mica, talc, melamine and calcium carbonate; one or more pigments and/or colorants such as titanium dioxide, iron oxide, chromium oxide, azo/diazo dyes, phthalocyanines, dioxazines and carbon black; one or more biocides; one or more preservatives; one or more antioxidants; one or more flame retardants; and the like.

The formulated polyol composition of the invention can be made by simple mixing of components a)-c), and optionally one or more of components d)-e) (and g) as described below, if used). If component c) or other ingredient (other than a filler, reinforcing agent or pigment) is a room temperature solid, it is preferred to heat such a component to melt or soften it before combining it with component a), and the resulting mixture cooled before the hydrocarbon blowing agent is added. The hydrocarbon blowing agent should be combined with the other ingredients at a temperature below its boiling temperature. Upon mixing all ingredients, the formulated polyol composition should be stored at a temperature below the boiling temperature of the hydrocarbon blowing agent and/or in a pressurized container to prevent the hydrocarbon from volatilizing.

Foam is made in accordance with the invention by combining components a)-e) (and g) as described below, if present) as described above with component f) at least one organic polyisocyanate to produce a reaction mixtures which is then cured under conditions such that component b) volatilizes and components a) and f) (and g), if present) react to produce the polymeric foam. The isocyanate index (100 times the ratio of isocyanate groups to isocyanate-reactive groups provided to the reaction mixture) is at least 90, preferably at least 100 or at least 110. When a polyurethane-isocyanurate foam is desired, the isocyanate index preferably is at least 200, at least 250 or at least 300. In some embodiments, the isocyanate index may be up to 1000, up to 600, up to 500 or up to 450.

Any two or more of components a)-e) may be formed into a formulated polyol composition as described above, prior to being combined with the organic polyisocyanate to produce the foam. In preferred embodiments, a formulated polyol composition comprising at least components a)-c) (and optionally any one or more of components d), e) and g)) is first prepared, and the reaction mixture is formed by combining the previously-formed polyol composition with the polyisocyanate. It is within the scope of the invention, however, to produce the reaction mixture by bringing the various components together all at once, or in various subcombinations. In particular, the hydrocarbon blowing agent may be mixed with the polyol and other components at the time the reaction mixture is prepared and the foam is made.

The organic polyisocyanate may have an isocyanate equivalent weight of 80 to 500, with a preferred equivalent weight being 120 to 250 or 125 to 150. The organic isocyanate may contain an average of at least 2 to about 4 isocyanate groups per molecule. Examples of useful polyisocyanates include m-phenylene diisocyanate, toluene-2,4-diisocyanate, toluene-2,6-diisocyanate, naphthylene-1,5-diisocyanate, methoxyphenyl-2,4-diisocyanate, diphenylmethane-4,4′-diisocyanate, diphenylmethane-2,4′-diisocyanate, diphenylmethane-2,2′-diisocyanate, 4,4′-biphenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 4,4′,4″-triphenyl methane triisocyanate, polymethylene polyphenylisocyanate (PMDI) having 3 or more phenyl isocyanate groups, toluene-2,4,6-triisocyanate and 4,4′-dimethyldiphenylmethane-2,2′,5,5′-tetraisocyanate. Any of the foregoing aromatic isocyanates may be modified to contain one or more urethane, urea, allophanate, biuret, carbodiimide or uretonimine linkages or any combination of any two or more thereof.

Preferably the polyisocyanate is diphenylmethane-4,4′-diisocyanate, diphenylmethane-2,4′-diisocyanate, diphenylmethane-2,2′-ddisocyanate, PMDI, or mixtures of any two or more thereof. Diphenylmethane-4,4′-diisocyanate, diphenylmethane-2,4′-diisocyanate and diphenylmethane-2,2′-diisocyanate and mixtures thereof are generically referred to as MDI, and all can be used. “Polymeric MDI”, which is a mixture of PMDI and MDI, can be used, in particular a polymeric MDI that contains at most 70% by weight MDI, especially 50 to 70% by weight MDI.

In some embodiments, the polyisocyanate is a polymeric MDI having an isocyanate equivalent weight of 126 to 150 and an average isocyanate functionality of 2.2 to 3.5.

Curing conditions are selected such that the blowing agent volatilizes and components a) and f) (and g) if present) react to produce a polymeric foam. The conditions typically include a temperature above the boiling temperature of the hydrocarbon blowing agent at the pressures employed. Components a) and f) typically will react spontaneously when mixed, even at room temperature, and the exothermic heat of reaction is often sufficient to produce the temperature needed to volatilize the hydrocarbon blowing agent. Therefore, it is often necessary only to form the reaction mixture at or about room temperature, such as 10 to 35° C., and allow the curing reaction to proceed without further applied heat. However, if desired, the components can be heated at the time of or prior to forming the reaction mixture, and/or the reaction mixture can be heated to an elevated temperature to promote the curing reaction.

In some embodiments the foam is produced by introducing the reaction mixture into a cavity or defined space where the expansion and curing takes place. The cavity or defined space may be, for example, a thermal insulation panel or wall, such as a wall of a refrigerator, freezer or cooler. The cavity may be a space between facing layers, as in producing sandwich panels for the construction or transportation industries. In such embodiments, the expansion of the reaction mixture is constrained by the geometry of the cavity, the cured form taking the shape defined by the interior surfaces of the cavity.

In other embodiments, the foam is produced in a continuous process by continuously dispensing the reaction mixture onto a moving belt or substrate. The substrate may be a facing sheet or panel, and a second layer of a facing sheet or panel may be continuously laid on top of the reaction mixture to form a sandwich structure. The reaction mixture is cured to form a foam adherent to the substrate(s).

Alternatively, the foam can be produced in a free-rise process in which the foam formulation is dispensed into an open area and permitted to rise freely in the vertical direction to produce bunstock.

Polymeric foam of the invention may have a foam density of, for example, 20 to 120 kg/m³ or 30 to 80 kg/m³.

The following examples are provided to illustrate the invention, but are not intended to limit the scope thereof. All parts and percentages are by weight unless otherwise indicated. All molecular weights are number averages by gel permeation chromatography.

The compatibility of each of three polyester polyols with n-pentane is evaluated by mixing 15 parts of n-pentane with 100 parts of the polyol at room temperature for one minute on a high-speed laboratory mixer. The resulting mixture is weighed to determine the amount of pentane that has been absorbed by the polyol (and by subtraction the amount of pentane that has volatilized during the mixing process). An additional amount of n-pentane equal to the amount of n-pentane that has volatilized is added to the polyol/pentane mixture, again at room temperature and with mixing for one minute. The weight of the mixture is measured again. The weight of n-pentane in the mixture is determined. The retained n-pentane is calculated as the weight of the n-pentane in the polyol/pentane mixture divided by the combined weight of the two additions of n-pentane.

The mixture in each case is allowed to sit at room temperature for 24 hours and then visually examined for phase separation. The volume of the n-pentane-rich upper phase is measured as a percentage of the total volume of the mixture.

The polyester polyols evaluated are as follows:

Polyol A: a terephthalic acid/diethylene glycol polyester polyol having a hydroxyl functionality of 2 and a hydroxyl number of 215. Polyol A corresponds to component a) of the invention. It contains no pendant hydrocarbon chains.
Polyol B: An orthophthalic anhydride/diethylene glycol polyester polyol having a hydroxyl functionality of 2 and a hydroxyl number of 320. It contains no pendant hydrocarbon chains.
Polyol C: a hydrophobically-modified phthalic anhydride/diethylene glycol polyester polyol having a hydroxyl functionality of 1.5-2 and a hydroxyl number of 234, made in accordance with U.S. Pat. No. 6,345,022.

Results are as indicated in Table 1.

TABLE 1

| | Polyol A | Polyol B | Polyol C |
|---|---|---|---|
| Retained n-pentane (%) | 45 | 61 | 69 |
| % Upper phase volume | 5.7% | 0 | 0 |

These results demonstrate the significantly different solubility characteristics of orthophthalate-based and terephthalate-based polyester polyols, as well as the effect of hydrophobic modification of a phthalate-based polyol. The terephthalate ester retains far less n-pentane and is more prone to stratify into an upper layer that is rich in n-pentane and one or more relatively n-pentane poor lower layers. Hydrophobic modification of the orthophthalate-based polyester polyol increases the amount of n-pentane that is retained.

### Examples 1 and 2 and Comparative Sample A

Blends of Polyol A and various surfactants, at various surfactant concentrations, are evaluated for n-pentane retention and % upper phase volume in the manner described above. Solid surfactants are melted before blending with the polyol. The surfactants are:

For Comp. Sample A: An oligoethylene block-poly(ethylene glycol) containing 67% oxyethylene units. This surfactant has a molecular weight of 642 g/mol and an HLB of 12.6 (Surfactant A). It is a room temperature liquid.

For Ex. 1: A block copolymer of ethylene oxide and propylene oxide having a molecular weight of 5900 and an HLB of 15 (Surfactant B). This surfactant is a waxy solid at room temperature.

For Ex. 2: An oligoethylene block-poly(ethylene glycol) containing 90% oxyethylene units. This surfactant is a room temperature solid having a molecular weight of 1960 g/mol and an HLB of 18 (Surfactant C).

Results of the testing are as indicated in Table 2.

TABLE 2

| | Comp. A | | Ex. 1 | | Ex. 2 | |
|---|---|---|---|---|---|---|
| % Surfactant¹ | Surfactant HLB | | | | | |
| (parts | 12.6 | | 15 | | 18 | |
| surfactant | | % Upper | | % Upper | | % Upper |
| per 100 part | Retained | Phase | Retained | Phase | Retained | Phase |
| Polyols A) | n-pentane | Volume | n-pentane | Volume | n-pentane | Volume |
| 10 (11.1) | 65.5 | 10 | N.D. | N.D. | N.D. | N.D. |
| 5 (5.3) | 66.7 | 10.3 | 80.0 | 0 | N.D. | N.D. |
| 2 (2.2) | N.D. | N.D. | 68.7 | N.D. | N.D. | N.D. |
| 1 (1) | N.D. | N.D. | 75.3 | 12.5 | 65.6 | 0 |
| 0.5 (0.5) | N.D. | N.D. | 56.7 | 14.8 | 56.0 | 0 |
| 0.25 (0.25) | N.D. | N.D. | 54.7 | 13.2 | 67.3 | 5.7 |

*Comparative.
¹Based on combined weight of surfactant and polyol.

This data demonstrates the effect of surfactant HLB on compatibility. A surfactant with an HLB of 12.6 (Comp. Sample A) is poorly effective even when used at high concentrations of 5-10%. Mixtures containing that surfactant stratify easily upon standing.

In Example 1, the presence of 5% of a surfactant with an HLB of 15 results in very high retained n-pentane and no stratification into layers. A surfactant level as low as 1% results in better n-pentane retention than 5% of the 12.6 HLB surfactant of Comp. Sample A.

In Example 2, the 18 HLB surfactant, at levels as low as 0.25%, is at least as effective as 5% of the 12.6 HLB surfactant of Comp. Sample A in retaining n-pentane and preventing stratification. No stratification is seen even at the 0.5% surfactant level, and at the 1% surfactant level the retained n-pentane is as high as seen with 5% surfactant in Comparative Sample A.

### Examples 3-4 and Comparative Samples B-C

Blends of Polyol A and various surfactants are evaluated for n-pentane retention and % upper layer volume in the manner previously described. The amount of surfactant and results of the testing are as indicated in Table 3.

The surfactants used in the various experiments are:
Comp. B: A liquid triblock copolymer having a central poly(propylene oxide) blocks and terminal poly(ethylene oxide) blocks. This surfactant has a molecular weight of 2900 and an HLB of 8 (Surfactant D).
Comp. C: A solid (at room temperature) triblock copolymer having a central poly(propylene oxide) blocks and terminal poly(ethylene oxide) blocks. This surfactant has a molecular weight of 2000 and an HLB of 10 (Surfactant E).
Comp. D: A liquid oligoethylene block poly(ethylene glycol) having a molecular weight of 420 and an HLB of 11 (Surfactant F).
Ex. 3: A room temperature solid PO-EO-PO triblock copolymer having a molecular weight of 8400 and an HLB of 16 (Surfactant G).
Ex. 4: A room temperature solid polyethylene/polyethylene glycol block copolymer. It has a molecular weight of 2250 and an HLB of 16 (Surfactant H).

TABLE 3

| | Comp. B* | Comp. C* | Comp D* | Ex. 3 | Ex. 4 |
|---|---|---|---|---|---|
| Surfactant HLB | 8 | 10 | 11 | 16 | 16 |
| % Surfactant¹ (parts | 5 (5.3) | 5 (5.3) | 5 (5.3) | 1 (1) | 1 (1) |
| surfactant per 100 part | | | | | |
| Polyols A) | | | | | |
| Retained n-pentane, % | 30 | 37 | 45 | 59 | 49 |
| % Upper phase volume | 8.8 | 14.0 | 9.6 | 0 | 0 |

*Comparative.
¹Based on combined weight of surfactant and polyol.

The higher amounts of retained n-pentane and lower upper phase volumes of the examples of the invention are clear indications of improved compatibilization of the blowing agent and terephthalate-based polyester polyol.

Sandwich panels having outer metal facing layers and a central foam layer are prepared using the following standard foam formulation. All ingredients except the polyisocyanate are formed into a polyol composition. The polyol composition is then combined with the polyisocyanate to produce a reaction mixture that is applied onto one of the metal facing layers and formed into a layer. The other facing layer is brought into position above the layer of the polyol composition. The polyol composition rises and cures in contact with the facing layers to form a urethane-modified polyisocyanurate foam having a thickness of 10 mm and a foam density as indicated in Table 4. The amount and type of surfactant also are as indicated Table 4.

Standard Foam Formulation

| Ingredient | Parts by Weight |
|---|---|
| Polyol A | 87.9 |
| Surfactant¹ | ¹ |
| Triethyl phosphate | 9.9 |
| Silicone surfactant | 3.8 |
| Water | 0.6 |
| Amine catalysts | 0.58 |
| Trimerization catalyst | 1.6 |
| 70/30 cis-/isopentane | 20 |
| mixture | |
| Polymeric MDI² | To 400 index |

¹See Table 4.
²Isocyanate content 30-31.4%, isocyanate functionality 2.8.

Tensile bond strength is measured on the resulting panels. 50 mm×50 mm×10 mm (foam thickness) sections are cut. A tensile force is applied perpendicular to the plane of the metal facings, and the force required to separate the foam from one of the metal facings is measured.

Surface smoothness is evaluated as an indication of how well the blowing agent became compatibilized in the polyol formulations. After removing a metal facing layer, the resulting exposed foam surface is painted black with a roller. Photos of the painted surface are taken. The images are processed using IMAGEJ Version 1.52A software, by selecting process/binary/operations and checking the “black background” box, so pixels with value 0 are shown as black and those set at 255 are shown as white. Using the threshold tool, the image/adjust/threshold is selected and the “dark background” box is checked. The lower threshold is adjusted to a value that will highlight most of the pixels in red, and “apply” is selected to obtain a binary image. Edit/selection/create selection is selected to select only the white pixels. By selecting analyze/measure, an area value is produced that represents white pixels, which is an indication of the surface smoothness.

Results of the testing are as indicated in Table 4.

TABLE 4

| | Surfactant type, amount¹ | | | | | |
|---|---|---|---|---|---|---|
| | (parts per 100 parts of Polyol A) | | | | | |
| | D, 5% | E, 5% | B, 5 | G, 1 | H, 1 | C, 1 |
| | (5.3) | (5.3) | (5.3) | (1) | (1) | (1) |
| HLB | 8 | 10 | 15 | 16 | 16 | 18 |
| Foam Density, g/L | 39.5 | 38.5 | 43.5 | 38.5 | 39 | 40 |
| TB², bottom, kPa | 180 | 180 | 200 | 150 | 200 | 200 |
| TBS², top, kPa | 130 | 150 | 150 | 150 | 100 | 150 |
| Smooth surface, % | 41 | 52 | 70 | 77 | 80 | 86 |

¹Based on combined weight of surfactant and polyol.
²TBS is tensile bonding strength.

As shown in Table 4, the foams made using surfactants having an HLB of 15-18 have much smoother surfaces than those made with a surfactant having a lower HLB. The improved surface smoothness is an indication of better compatibilization of the pentane blowing agent into the terephthalate-based polyester polyol. Adhesion to the metal facing panels remains good and foam density is essentially unchanged.

1. A formulated polyol composition comprising:
a) at least one polyester polyol containing one or more terephthalic acid ester groups, the polyester polyol having a number average of at least 1.5 hydroxyl groups per molecule and a hydroxyl number of 150 to 350, or a mixture of at least 50 weight-% based on the weight of the mixture of the polyester polyol with up to 50 weight-% of one or more other polyols having a number average of at least 1.5 hydroxyl groups per molecule and a hydroxyl number of 150 to 350;
b) 5 to 30 parts by weight, per 100 parts by weight of component a), of one or more aliphatic hydrocarbons having 4 to 7 carbon atoms;
c) 0.25 to 20 parts by weight, per 100 parts by weight of component a), of one or more nonionic surfactants having a hydrophilic-lipophilic balance (HLB) of greater than 13 and up to 18.5.

2. The formulated polyol composition of claim 1 wherein the nonionic surfactant is selected from the group consisting of an ethoxylate of a fatty alcohol and/or fatty acid; a block copolymer of propylene oxide and/or butylene oxide and ethylene oxide; and an ethoxylate of a polyethylene oligomer, and the nonionic surfactant has an HLB of 14 to 18.

3. The formulated polyol composition of claim 2 which contains 0.5 to 10 parts by weight of the nonionic surfactant per 100 parts by weight of component a).

4. The formulated polyol composition of claim 2 wherein the polyester polyol containing one or more terephthalic acid ester groups has a number average of 2 to 2.5 hydroxyl groups per molecule and a hydroxyl number of 200 to 275.

5. The formulated polyol composition of claim 2 wherein the polyester polyol containing one or more terephthalic acid ester groups does not contain a pendant aliphatic hydrocarbon group having 6 or more carbon atoms.

6. The formulated polyol composition of claim 2 wherein the polyester polyol containing one or more terephthalic acid ester groups constitutes at least 85% of the weight of component a).

7. The formulated polyol composition of claim 2 wherein component c) includes at least 95% by weight of one or more pentane isomers.

8. The formulated polyol composition of claim 2 further comprising d) one or more foam-stabilizing surfactants and e) one or more urethane and/or isocyanate trimerization catalysts.

9. A method of making a polymeric foam, comprising
A) forming a reaction mixture containing
a) at least one polyester polyol containing one or more terephthalic acid ester groups, the polyester polyol having a number average of at least 1.5 hydroxyl groups per molecule and a hydroxyl number of 150 to 350, or a mixture of at least 50 weight-% based on the weight of the mixture of the polyester polyol with up to 50 weight-% of one or more other polyols having a number average of at least 1.5 hydroxyl groups per molecule and a hydroxyl number of 150 to 350;
b) 5 to 30 parts by weight, per 100 parts by weight of component a), of one or more aliphatic hydrocarbons having 4 to 7 carbon atoms;
c) 0.5 to 20 parts by weight, per 100 parts by weight of component a), of one or more nonionic surfactants having a hydrophilic-lipophilic balance (HLB) of greater than 13 and up to 18.5;
d) one or more foam-stabilizing surfactants;
e) one or more urethane and/or trimerization catalysts and
f) at least one organic polyisocyanate in an amount sufficient to provide an isocyanate index of at least 90 and
B) curing the reaction mixture under conditions such that component b) volatilizes and components a) and f) react to produce the polymeric foam.

10. The method of claim 9 wherein the nonionic surfactant is selected from the group consisting of an ethoxylate of a fatty alcohol and/or fatty acid; a block copolymer of propylene oxide and/or butylene oxide and ethylene oxide; and an ethoxylate of a polyethylene oligomer, and the nonionic surfactant has an HLB of 14 to 18.

11. The method of claim 10 wherein which contains 0.5 to 10 parts by weight of the nonionic surfactant per 100 parts by weight of component a).

11. The method of claim 10 wherein the polyester polyol containing one or more terephthalic acid ester groups has a number average of 2 to 2.5 hydroxyl groups per molecule and a hydroxyl number of 200 to 275.

13. The method of claim 10 wherein the polyester polyol containing one or more terephthalic acid ester groups does not contain any pendant aliphatic hydrocarbon groups of 6 or more carbon atoms.

14. The method of claim 10 wherein the polyester polyol containing one or more terephthalic acid ester groups constitutes at least 85% of the weight of component a).

15. The method of claim 10 wherein component c) includes at least 95% by weight of one or more pentane isomers.
